(19) United States
(12) Patent Application Publication
(10) Pub. No.: US 2005/0224031 A1
(43) Pub. Date: Oct. 13, 2005

(54) Vehicle cabin heating system with wax motor three-way valve

(76) Inventors: Steven R. Knight, Portland, CT (US); Martin C. Maxwell, Canton, CT (US)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 11/105,185

(22) Filed: Apr. 13, 2005

Related U.S. Application Data
(60) Provisional application No. 60/561,693, filed on Apr. 13, 2004.

(51) Int. Cl. F02N 17/02

(52) U.S. Cl. 123/142.5 R

(57) ABSTRACT

The present invention provides a wax motor actuated valve assembly for controlling the flow of coolant to a heater core or cores until the coolant reaches a predetermined operating temperature. The wax motor actuated valve has particular application to vehicle cabin heating systems comprising front and rear heat exchangers (cores) over which air can pass for heating front and rear portions of the cabin, respectively. Initially, flow to the rear heat exchanger is shut off until the temperature of the coolant reaches a predetermined elevated temperature, whereby initial coolant flow is directed to the front heat exchanger for more rapid heating of the forward portion of the vehicle cabin. After the predetermined elevated temperature has been reached, the wax motor valve assembly is actuated to supply coolant to the rear heat exchanger for heating the rear portion of the vehicle cabin.

### RELATED APPLICATIONS

This application claims the benefit of U.S. Provisional Application No. 60/561,693 filed Apr. 13, 2004, which is hereby incorporated herein by reference.

### FIELD OF THE INVENTION

The present invention relates generally to vehicle cabin heating systems and particularly those employing front and rear heat exchangers. The invention also relates to a valve having particular application in such heating system and more particularly to a wax motor actuated valve having a stepped bore.

### BACKGROUND OF THE INVENTION

Motor vehicles generally include heating units to heat the interior of the vehicle (i.e., the cabin). In many automotive applications, a single heat exchanger, also known as a heater core, is located in the front of the vehicle beneath the dashboard. The heater core is normally connected to the water jacket of the vehicle's engine through a coolant circuit. When engine coolant passes through the water jacket, heat is transferred from the engine to the coolant thereby cooling the engine and heating the engine coolant. The heated coolant is then circulated through the heater core for the purpose of heating the cabin. Air is passed over the heater core where it is heated before being discharged into the cabin. However, a significant amount of time can be required to warm the cabin, particularly when an engine is cold and is first started.

The time required to heat the cabin can be even greater in vehicles with large engines and/or large passenger compartments, such as sport utility vehicles (SUVs). SUVs and other large vehicles generally have larger engines with increased engine cooling capacity and, therefore, the engine coolant can take longer to warm up. Further, the volume of the cabin is often larger thereby requiring more heating capacity to warm the air in the cabin. In some instances vehicles are equipped with a second heater core for providing additional heat, typically to the rear of the cabin. The second heater core is also connected to the water jacket of the engine via a coolant circuit and the heat carried by the engine coolant is used to warm the rear of the cabin by passing air over the second heater core and into the cabin of the vehicle.

Due to the additional volume of engine coolant required in a heating system having two heater cores, the amount of time required to initially heat the engine coolant can be longer than in a single heater core system. Although a two heater core system can provide greater heating capacity, it can take a longer time to begin to heat the cabin when starting a cold engine.

### SUMMARY OF THE INVENTION

The present invention provides a wax motor actuated valve assembly for controlling the flow of coolant to a heater core or cores until the coolant reaches a predetermined operating temperature. The wax motor actuated valve has particular application to vehicle cabin heating systems comprising front and rear heat exchangers (cores) over which air can pass for heating front and rear portions of the cabin, respectively. Initially, flow to the rear heat exchanger is shut off until the temperature of the coolant reaches a predetermined elevated temperature, whereby initial coolant flow is directed to the front heat exchanger for more rapid heating of the forward portion of the vehicle cabin. After the predetermined elevated temperature has been reached, the wax motor valve assembly is actuated to supply coolant to the rear heat exchanger for heating the rear portion of the vehicle cabin.

The wax motor provides high force without the drawbacks associated with the more conventional vacuum actuated motor used in automotive applications. In addition, both the application and the release of the wax motor is not instantaneous, but rather, smooth and gentle. Wax motors may also be controlled by triacs without the need for snubber circuits because the wax motor is a resistive load rather than an inductive load. Moreover, a wax motor may survive situations where the plunger is blocked from full travel.

Other aspects of the invention relate to the valve assembly construction. More particularly, the valve assembly may include a two-piece valve body forming a stepped bore that simplifies molding of the valve body while providing a larger flow area for a smaller stroke of a valve shuttle. The valve assembly additionally or alternatively may include a conforming sealing member that enables low tolerance valve components to behave like tight tolerance components, thereby reducing manufacturing costs. The valve assembly further may be provided with a low current switching circuit for controlling a high current heater circuit.

Accordingly, a vehicle cabin heating system according to a first aspect of the invention comprises first and second heat exchangers over which air can pass for heating the cabin, and a valve assembly for controlling flow of coolant to the first and second heat exchangers. The valve assembly includes a valve body, a valve shuttle movable in the valve body, and a valve actuator for moving the valve shuttle between first and second positions. The valve body has first and second outlets respectively connected to the first and second heat exchangers (cores) and an inlet, and the valve actuator includes a wax motor operatively connected to the valve shuttle for moving the valve shuttle from the first position that permits flow between the inlet and the first outlet to the second position that blocks flow between the inlet and the second outlet, thereby to restrict flow of coolant to the second heat exchanger.

According to another aspect of the invention, a valve assembly for controlling flow of coolant to a heat exchanger in a vehicle cabin, comprises a valve body having an inlet and an outlet connected via an interior bore defined by an annular, axially extending interior surface of the valve body that opens at one end to a radially enlarged cavity in the valve body; a valve shuttle supported in the valve body for axial movement between open and closed positions respectively permitting and blocking flow through the interior bore; and an actuator for moving the valve shuttle between its open and closed positions. The valve shuttle includes an annular, radially outwardly extending, conforming valve seal element for sealing against the annular interior surface of the valve body when the valve shuttle is in its closed position. The valve shuttle, when in its open position, locates the conforming valve seal element in the radially enlarged cavity for permitting flow through the interior passage.

The valve seal element is formed from a plastic material that will conform to the annular interior surface to effect a seal, preferably being designed to creep into a line on line seal after assembly. This takes advantage of a plastic's tendency to stress receive in a retained position. Consequently, lower tolerances can be used while still obtaining valve behavior similar to that obtained if tight tolerance components were used.

A particular valve seal element has an annular radially outer cup-shape portion that opens axially in the direction of the radially enlarged cavity and an annular radially inner cup-shape portion that opens axially in the direction opposite the radially outer cup-shape portion. More particularly, the valve seal element has a S-shape in cross-section, with respective halves of the S forming the radially inner and outer cup-shape portions. The radially inner cup-shape portion may have a larger axial extent than the radially outer cup-shape portion.

The valve shuttle may be resiliently biased toward its open position, particularly when the actuator includes a wax motor. The wax motor may have a low current switching circuit and a high current heating circuit controlled by the low current switching circuit, the high current circuit including a heating element for heating the expansion wax of the wax motor.

According to a further aspect of the invention, a valve assembly for controlling flow of coolant to a heat exchanger in a vehicle cabin comprises a valve body including first and second parts defining a stepped bore, with the step of the stepped bore being formed at the interface of a smaller diameter bore in the first valve body part with a larger diameter bore in the second valve body part. A valve shuttle is supported in the valve body for axial movement between open and closed positions, the valve shuttle including a valve element for circumferentially sealing to the smaller diameter bore, and a wax motor is used to axially move the valve plunger between the open and closed positions. The first and second parts desirably are configured such that they can be snapped together.

The foregoing and other features of the invention are hereinafter fully described and particularly pointed out in the claims, the following description and the annexed drawings setting forth in detail one or more illustrative embodiments of the invention, such being indicative, however, of but one or a few of the various ways in which the principles of the invention may be employed.

### BRIEF DESCRIPTION OF THE DRAWINGS

FIG. 1 is a schematic diagram illustrating an automobile heating and/or cooling system including a valve in accordance with the present invention.

FIG. 2 is a cross-sectional view of a valve in the open position in accordance with the present invention.

FIG. 3 is another cross-sectional view of the valve of FIG. 2 rotated 90 degrees in accordance with the present invention.

FIG. 4 is a cross-sectional view of the valve of FIG. 2 in the closed position in accordance with the present invention.

### DETAILED DESCRIPTION

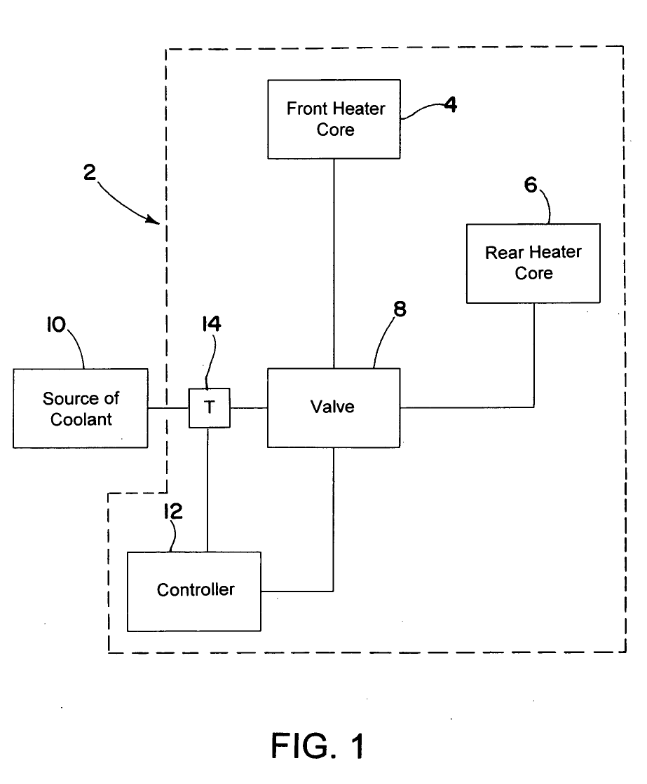

Referring now to the drawings in detail, and initially to FIG. 1, an exemplary vehicle heating system 2 in accordance with the invention generally comprises at least one heater core and a valve for controlling flow of coolant to the heater core. In the illustrated embodiment particularly suited for use in an sport utility vehicle (SUV) or other vehicle have a large interior cabin, there are two heater cores, a front heater core 4 and a rear heater core 6. The heater cores are connected by the valve 8 to a source of coolant, such as the engine coolant system 10 of the vehicle that extracts waste heat from the engine. The valve 8 is controlled by a controller 12 which modulates the valve 8 between open and closed positions in response to the temperature of the coolant that is sensed by a temperature sensor 14. In the illustrated embodiment and as is discussed further below, the valve 8 is configured to allow or shut off flow to the rear heater core 6 while continuously permitting flow of coolant to the front heater core 4.

Although not shown, the system will also include return lines for allowing coolant to flow from the heater cores back to the engine coolant system. It will also be appreciated that the valve 8 can be located on the return side of the heater cores rather than on the supply side, with similar results being obtained.

In operation, the sensor 14 provides to the controller 12 a signal indicative of the temperature of the coolant. When the engine is cold, the coolant temperature also will initially be cold. At this time the valve 8 will be in its closed position whereby coolant can flow to the front heater core 4 but not to the rear heater core 6. Consequently, as the coolant is warmed by the engine, coolant will flow to the front heater core 4 for heating the corresponding region of the vehicle cabin. No coolant will flow to the rear heater core 6, thereby reducing the thermal demand on the coolant and allowing the coolant to heat up quicker and provide for more efficient heating of the cabin region serviced by the front heater core 4. After the coolant reaches a predetermined operating temperature, the controller 12 commands the valve 8 to its open position thereby allowing coolant to flow to the rear heater core 6 for heating of the corresponding region of the vehicle cabin, while coolant continues to be supplied to the front heater core 4.

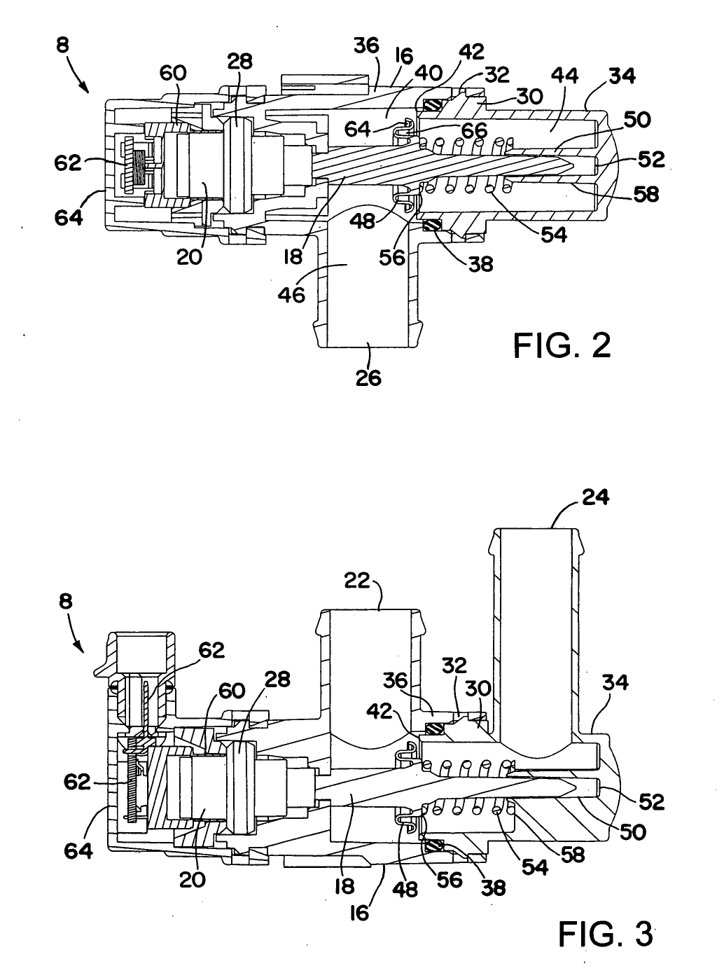

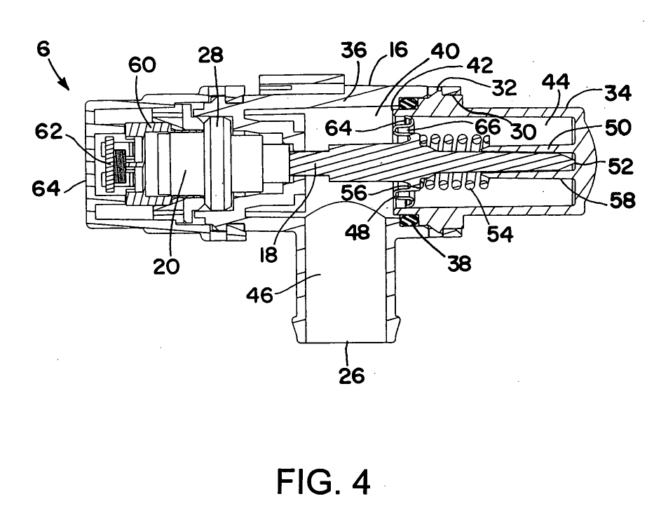

Referring now to FIGS. 2-4, the valve assembly 8 generally comprises a valve body 16, a valve shuttle 18 movable in the valve body 16, and a valve actuator 20 for moving the valve shuttle 18 between first and second positions. The valve body 16 having a primary outlet 22 and a secondary outlet 24 for connection to the front and rear heater cores 4 and 6, respectively, and an inlet 26 for connection to the coolant source 10. In the illustrated embodiment, the valve actuator 20 includes a wax motor 28 operatively connected to the valve shuttle 18 for moving the valve shuttle 18 from an open position (FIG. 2) that permits flow between the inlet 26 and the secondary outlet 24 to a closed position (FIG. 4) that blocks flow between the inlet 26 and the secondary outlet 24, thereby to restrict or block flow of coolant to the rear heater core 6. As above mentioned, in the illustrated valve assembly 8, the inlet 26 is always in communication with the primary outlet 22 that is connected to the front heater core 4. Of course, other configurations could be provided if desired.

In the illustrated embodiment the valve body 16 is formed from two parts that may be configured as shown for a snap fit connection effected by interlocking devices 30 and 32. As shown, the devices 30 and 32 may be one or more radial recesses (e.g. holes) and corresponding detent elements configured to latch in respective holes when the two parts are axially pressed together. As shown, the valve body 16 includes an axially outer part 34 having a cylindrical collar portion sized to closely fit in a cylindrical sleeve portion of an axially inner body part 36. The collar portion has the latching detents projecting radially therefrom and the sleeve portion has the latching holes formed therein. In order to effect a fluid tight seal between the outer and inner body parts 34 and 36, the collar portion is radially recessed at its axially inner end for accommodating an annular seal 38, such as an O-ring, between the collar and sleeve portions as shown. In the illustrated embodiment, the radial recess opens to an axial end face of the collar portion, and the sleeve portion is provided with a radially inwardly extending shoulder for axially capturing the annular seal 38.

As is preferred, the outer and inner body parts 34 and 36 define a stepped bore 40, with the step 42 of the stepped bore 40 being formed at the interface of a smaller diameter reduced bore 44 in the outer body part 34 with a larger diameter enlarged bore 46 forming an enlarged cavity in the inner body part 36. As discussed further below, the valve shuttle 18 includes a valve sealing element 48 for circumferentially sealing to the smaller diameter reduced bore 44.

The reduced bore 44 in the outer valve body part 34 opens at its inner end to an axial end face. The enlarged bore 46 in the inner body part 36 opens outwardly toward the outer body part 34 and, as shown, receives with a slight overlap the axially inner end of the outer body part 34. The step 42 of the stepped bore 40 is formed by the axial end face of the outer body part 34. This arrangement and configuration simplifies molding of the valve body 16 while providing a larger flow area for a smaller stroke of a valve shuttle 18.

The valve shuttle 18 is supported for axial movement between its open and closed positions in the valve body 16. One end of the shuttle 18 is coupled to the wax motor 28 while the other end is received in a shuttle guide 50. A shuttle stop 52 is provided in the reduced bore valve body part 34 to limit travel of the valve shuttle 18. A spring 54, or other resilient member, biases the shuttle 18 towards its open position shown in FIG. 2. The spring 54 is interposed between a flange 56 on the shuttle 18 and a spring retainer 58 on the outer body part 34.

As above indicated, the valve shuttle 18 is moved from its open position to its closed position, against the spring biasing force, by the wax motor 28. The wax motor 28 may be of a conventional type including a casing and wax (not shown), a heating element 60, and plunger (not shown) which may be formed integrally with or coupled to the valve shuttle 18. Suitable electronics 62 for supplying power to the heating element 60 may be housed in a cap 64 connected to the valve body 16, such as by a snap fit connection as shown. In the illustrated embodiment, the wax motor 28 has a low current switching circuit and a high current heating circuit controlled by the low current switching circuit, the high current circuit including the heating element 60 for heating the expansion wax of the wax motor 28. More particularly, the wax motor 28 circuitry may include a triac whereby, in a known manner, high current flow to the heater element 60 can be controlled by a low current command input provided by the controller 12. Accordingly, the cap 64 may be equipped with three terminals 62, one for ground, one for the low current control input, and the other for high current flowing to the heating element 60.

Wax motors 28 can provide high force without the drawbacks associated with the more conventional vacuum-actuated motors used in many automotive applications. For example, the use of a wax motor 28 eliminates the need for vacuum line plumbing and the drawbacks associated therewith. In addition, both the application and the release of the wax motor 28 is not instantaneous, but rather smooth and gentle. Wax motors 28 may also be controlled by triacs without the need for snubber circuits because the wax motor is a resistive load rather than an inductive load. Moreover, a wax motor 28 may survive situations where the plunger is blocked from full travel.

The wax motor 28 acts on the end of the valve shuttle 18 and functions to axially move the valve shuttle 18 from its open position (FIG. 2) to its closed position (FIG. 4). When the heating element 60 is energized, the wax expands to drive the valve shuttle 18 with high force to the right in FIG. 2 for moving the sealing element 48 into sealing engagement with the interior surface of the outer body part 34 surrounding the reduced diameter bore 44 therein. When power is removed from the heating element 60, the wax shrinks in volume as it cools, thereby allowing the valve shuttle 18 to return to its open position under the influence of the spring 54. Although the illustrated valve 8 is configured as a normally open valve, it will be appreciated that the valve 8 can easily be configured to be normally closed.

The sealing element 48 of the valve shuttle 18 may be an annular, radially outwardly extending, conforming valve seal element for sealing against the annular interior surface of the valve body 16 when the valve shuttle 18 is in its closed position. The sealing element 48 may be secured to the valve shuttle 18 by any suitable means. The valve sealing element 48 may molded from a suitable flexible plastic material, such as mylar or other suitable plastic, that will conform to the annular interior surface of the valve body 16 to effect a seal when the valve shuttle 18 is in its closed position shown in FIG. 4. As shown, the valve sealing element 48 has an annular radially outer cup-shape portion 64 that opens axially in the direction of the radially enlarged cavity, and an annular radially inner cup-shape portion 66 that opens axially in the direction opposite the radially outer cup-shape portion 64. More particularly, the valve seal element 48 has a S-shape in cross-section, with respective halves of the S forming the radially inner and outer cup-shape portions. The radially inner cup-shape portion 66 has a larger axial extent than the radially outer cup-shape portion 64. Because of the sealing element's 48 configuration, pressurized coolant acting on the inlet side of the sealing element 48 will assist in holding the radially outer edge portion in tight sealing engagement with the interior bore surface.

As above noted, the valve sealing element 48 being formed from a plastic material will enable it to conform to the annular interior surface and thereby effect a tight line on line seal after assembly. This takes advantage of a plastic's tendency to stress relieve in a retained position. Consequently, lower tolerances can be used while still obtaining valve behavior similar to that obtained if tight tolerance components were used.

In operation, the valve assembly 8 operates to control the flow of a fluid from the inlet 26 to the secondary outlet 24. Fluid can flow from the inlet 26 to the primary outlet 22 regardless of whether the valve assembly 8 is open or closed. Thus, when the valve assembly 8 is closed as shown in FIG. 4, fluid can flow from the inlet 26 to the primary outlet 22, and when the valve assembly 8 is open as shown in FIGS. 2 and 3, fluid can flow from the inlet 26 to both the primary and secondary outlets 22 and 24. In the open position, the sealing member 48 is located in the enlarged bore 46 and generally maintained in the open position by the spring 54, thereby allowing fluid to flow from the enlarged bore 46 into the reduced bore 44 to the secondary outlet 24. As mentioned, fluid can also flow from the inlet 26 to the primary outlet 22 when the valve assembly 8 is in the open position.

In FIG. 4, the valve assembly 8 is illustrated in the closed position. To close the valve assembly 8, electric current is supplied to the heating element 60 of the wax motor 28. The heating element 60 of the wax motor 28 heats the wax which thereby expands and displaces the shuttle 18 towards the reduced bore valve body part 34 until the shuttle 18.abuts shuttle stop 52 as illustrated in FIG. 4. In this position, the sealing member 48 is disposed within the reduced bore 44 whereat the conforming sealing member 48 forms a circumferential seal against an inner diameter of the reduced bore 44 thereby blocking flow to the secondary outlet 24. The conforming sealing member 48 will be compressed radially when it is moved into the reduced bore 44 to facilitate the formation of a seal between the conforming sealing member 48 and the reduced bore 44.

In the closed position, the spring 54 is compressed between the spring retainer 58 and the shuttle 18. The compressed spring 54 exerts a force on the shuttle 18 that tends to return the shuttle 18 to the open position. Thus, it will be appreciated that the wax motor 28 must remain activated to maintain the shuttle 18 in the closed position.

To open the valve assembly 8 the electric current supplied to the heating element of the wax motor 28 is switched off. The wax cools and contracts thereby allowing the spring 54 to return the shuttle 18 to the open position of FIGS. 2 and 3. As the shuttle 18 returns to the open position, the conforming sealing member 48 moves into the enlarged bore 46 thereby opening the valve assembly 8 and allowing fluid to flow to the secondary outlet 24. It will be appreciated that the stepped bore 40 facilitates a greater fluid flow rate with a smaller displacement of the shuttle 18 than a similar valve assembly without a stepped bore.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A vehicle cabin heating system comprising first and second heat exchangers over which air can pass for heating the cabin, and a valve assembly for controlling flow of coolant to the first and second heat exchangers, the valve assembly including a valve body, a valve shuttle movable in the valve body, and a valve actuator for moving the valve shuttle between first and second positions, the valve body having first and second outlets respectively connected to the first and second heat exchangers and an inlet, and the valve actuator including a wax motor operatively connected to the valve shuttle for moving the valve shuttle from the first position that permits flow between the inlet and the first outlet to the second position that blocks flow between the inlet and the second outlet, thereby to restrict flow of coolant to the second heat exchanger.

2. A vehicle cabin heating system as set forth in claim 1, wherein the wax motor has a low current switching circuit and a high current heating circuit controlled by the low current switching circuit, the high current circuit including a heating element for heating the expansion wax of the wax motor.

3. A valve assembly for controlling flow of coolant to a heat exchanger in a vehicle cabin, comprising a valve body having an inlet and an outlet connected via an interior bore defined by an annular, axially extending interior surface of the valve body that opens at one end to a radially enlarged cavity in the valve body; a valve shuttle supported in the valve body for axial movement between open and closed positions respectively permitting and blocking flow through the interior bore; and an actuator for moving the valve shuttle between its open and closed positions; the valve shuttle including an annular, radially outwardly extending, conforming valve seal element for sealing against the annular interior surface of the valve body when the valve shuttle is in its closed position, and the valve shuttle, when in its open position, locating the conforming valve seal element in the radially enlarged cavity for permitting flow through the interior passage.

4. A valve assembly as set forth in claim 3, wherein the valve seal element is formed from a plastic material that will conform to the annular interior surface to effect a seal.

5. A valve assembly as set forth in claim 4, wherein the valve seal element has an annular radially outer cup-shape portion that opens axially in the direction of the radially enlarged cavity.

6. A valve assembly as set forth in claim 5, wherein the valve seal element has an annular radially inner cup-shape portion that opens axially in the direction opposite the radially outer cup-shape portion.

7. A valve assembly as set forth in claim 6, wherein the valve seal element has a S-shape in cross-section, with respective halves of the S forming the radially inner and outer cup-shape portions.

8. A valve assembly as set forth in claim 6, wherein the radially inner cup-shape portion has a larger axial extent than the radially outer cup-shape portion.

9. A valve assembly as set forth in claim 3, wherein the valve shuttle is resiliently biased toward its open position.

10. A valve assembly as set forth in claim 9, wherein the actuator includes a wax motor.

11. A vehicle cabin heating system as set forth in claim 10, wherein the wax motor has a low current switching circuit and a high current heating circuit controlled by the low current switching circuit, the high current circuit including a heating element for heating the expansion wax of the wax motor.

12. A valve assembly as set forth in claim 3, wherein the valve body includes first and second parts, the first part including the interior bore that terminates at an axial end face of the first part that forms a step between the interior bore and the radially enlarged cavity, and the second part including the radially enlarged cavity.

13. A valve assembly as set forth in claim 11, wherein the first and second parts snap together.

14. A valve assembly as set forth in claim 3, wherein the actuator includes a wax motor.

15. A valve assembly for controlling flow of coolant to a heat exchanger in a vehicle cabin, comprising a valve body including first and second parts defining a stepped bore, with the step of the stepped bore being formed at the interface of a smaller diameter bore in the first valve body part with a larger diameter bore in the second valve body part; a valve shuttle supported in the valve body for axial movement between open and closed positions, the valve shuttle including a valve element for circumferentially sealing to the smaller diameter bore; and a wax motor for axially moving the valve plunger between the open and closed positions.

16. A valve assembly as set forth in claim 15, wherein the valve sealing member is made of a plastic material.

17. A valve as set forth in claim 15, further comprising a wax motor operable to axially move the valve shuttle to the closed position.

18. A valve as set forth in claim 17, further comprising a resilient member for biasing the valve shuttle towards the open position.

19. A valve assembly as set forth in claim 15, wherein the valve seal element has a S-shape in cross-section.

20. A valve assembly as set forth in claim 15, wherein the first and second parts snap together.
